(19) United States
(12) Patent Application Publication
(10) Pub. No.: US 2014/0095199 A1
(43) Pub. Date: Apr. 3, 2014

(54) MEDICAL CARE PLAN PREPARATION SUPPORT APPARATUS, MEDICAL CARE PLAN PREPARATION SUPPORT METHOD AND NON-TRANSITORY COMPUTER READABLE MEDIUM

(71) Applicant: FUJI XEROX CO., LTD., (US)

(72) Inventor: Koji SATAKE, Yokohama-shi (JP)

(21) Appl. No.: 13/891,297

(22) Filed: May 10, 2013

(30) Foreign Application Priority Data
Oct. 2, 2012 (JP) 2012-220259

(51) Int. Cl. G06F 19/00; G06Q 50/24

(52) U.S. Cl. CPC G06F 19/34; G06Q 50/24
USPC 705/3

(57) ABSTRACT

It is provided a medical care plan preparation support apparatus which generates medical care plan display information based on medical care plan information and pattern information which is commonly included medical care history information of plural patients.

### CROSS-REFERENCE TO RELATED APPLICATIONS

This application is based on and claims priority under 35 U.S.C. 119 from Japanese Patent Application No. 2012-220259 filed on Oct. 2, 2012.

### BACKGROUND

### Technical Field

The present invention relates to a medical care plan preparation support apparatus and a medical care plan preparation support method and a non-transitory computer readable medium.

### SUMMARY

According to an aspect of the invention, a medical care plan preparation support apparatus, includes: a medical care information acquisition unit that acquires medical care information for each patient, in which medical care action information according to each medical care action and execution date information acquired from an execution date of each medical care action and a reference date set in advance, are associated with each other; a pattern information acquisition unit that acquires pattern information in which the medical care action information and the execution date information which are common to at least some of a plurality of patients are associated with each other, based on the medical care information; a medical care plan information acquisition unit that acquires medical care plan information in which the medical care action information and the execution date information which are set in advance are associated with each other; and a medical care plan display information generation unit that generates medical care plan display information indicating the medical care plan information, which (i) highlights the medical care action information according to the pattern information, which is included in both of the medical care plan information and the pattern information and (ii) defer highlighting the medical care action information which is included in the medical care plan information and not included in the pattern information.

### BRIEF DESCRIPTION OF THE DRAWINGS

Exemplary embodiment(s) of the present invention will be described in detail based on the following figures, wherein

FIG. 1 is a diagram for illustrating a schematic hardware configuration of a medical care plan preparation support system according to an embodiment of the present invention;

FIG. 2 is a diagram for illustrating a functional configuration of a control unit of a server illustrated in FIG. 1;

FIG. 3 is a diagram for explaining medical care history information;

FIG. 4 is a diagram for explaining category information;

FIGS. 5A to 5D are diagrams for explaining medical care information and a pattern information;

FIG. 6 is a diagram for explaining medical care plan information;

FIGS. 7A and 7B are diagrams for explaining medical care plan display information;

FIGS. 8A to 8E are diagrams for explaining an editing of medical care plan display information; and

FIG. 9 is a diagram for illustrating a process flow in the present embodiment.

### DETAILED DESCRIPTION

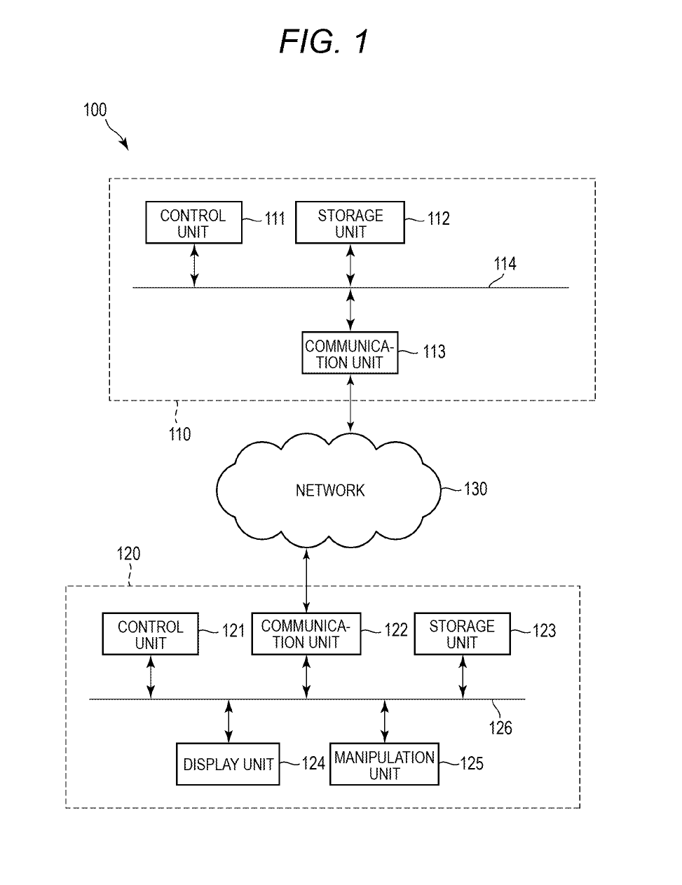

FIG. 1 is a diagram for illustrating a schematic hardware configuration of a medical care plan preparation support system according to an embodiment of the present invention. As illustrated in FIG. 1, a medical care plan preparation support system 100 includes a server 110 and a terminal 120 connected with each other via a network 130. Meantime, the medical care plan preparation support system 100 in FIG. 1 includes only a single terminal 120, but may include a plurality of other terminals 120.

The server 110 includes a control unit 111, a storage unit 112, and a communication unit 113. The control unit 111 is, for example, a CPU, and is operated according to a program stored in the storage unit 112. The storage unit 112 is an information recording medium which is configured by, for example, a hard disc, ROM or RAM and maintains a program executed by the control unit 111. Further, the storage unit 112 also serves as a work memory of the control unit 111.

The communication unit 113 is a network interface, and transmits and receives information via the network 130 according to an instruction from the control unit 111. In the meantime, the control unit 111, the storage unit 112, and the communication unit 113 are connected with one another via a bus 114.

Also, the terminal 120 includes a control unit 121, a communication unit 122, a storage unit 123, a display unit 124, and a manipulation unit 125. Similarly, the respective units 121 to 125 are connected with one another via a bus 126. Similarly to the server 110 as described above, the control unit 121 is, for example, a CPU and is operated according to a program stored in the storage unit 123. The storage unit 123 is an information recording medium which is configured by, for example, a hard disc, ROM or RAM, and maintains the program executed by the control unit 121. Further, the storage unit 123 serves as a work memory of the control unit 121.

The manipulation unit 125 is configured by an interface, such as for example, a keyboard, a mouse or a button, and outputs the contents of the manipulation instructed from a user according to the instruction manipulation by the user to the control unit 121. The display unit 124 is, for example, a liquid crystal display, a CRT display, or an organic EL display, and displays information according to an instruction from the control unit 121.

Meantime, the programs executed in the control units 111 and 121 may be provided either by being downloaded through, for example, a network, or by computer readable various information recording mediums such as a CD-ROM or a DVD-ROM. Meantime, a configuration of the server 110 or the terminal 120 is an illustrative example and is not limited thereto. Further, the functional configurations of the server 110 and the terminal 120 will be described in later.

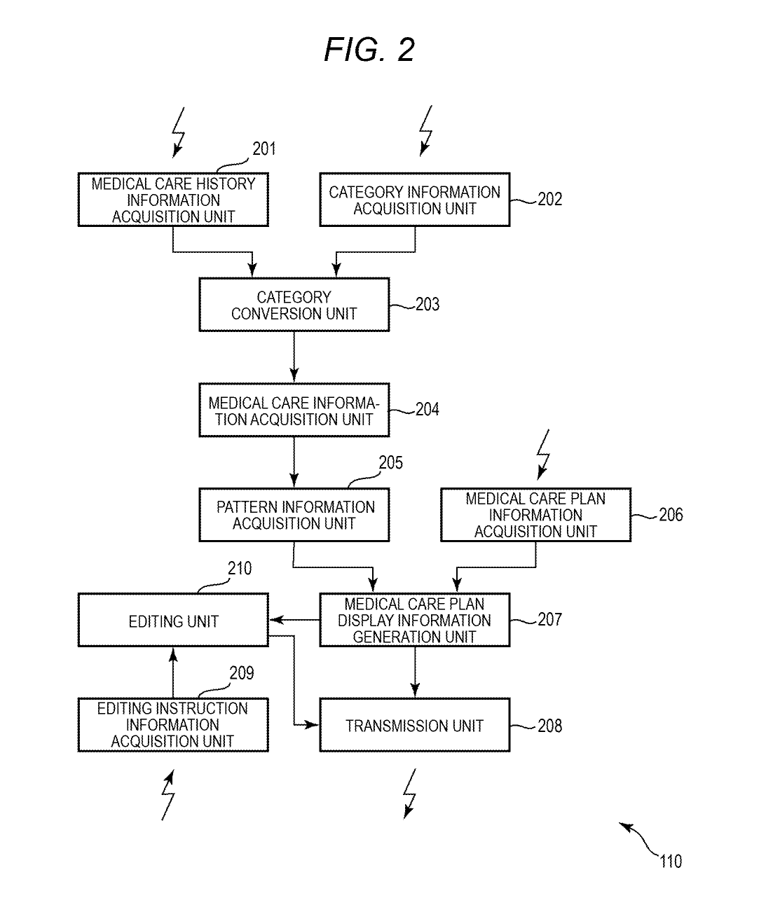

FIG. 2 is a diagram for illustrating a functional configuration of the control unit of the server illustrated in FIG. 1. As illustrated in FIG. 2, the control unit 111 of the server 110 functionally includes a medical care history information acquisition unit 201, a category information acquisition unit 202, a category conversion unit 203, a medical care information acquisition unit 204, a pattern information acquisition unit 205, a medical care plan information acquisition unit 206, a medical care plan display information generation unit 207, a transmission unit 208, an editing instruction information acquisition unit 209, and an editing unit 210.

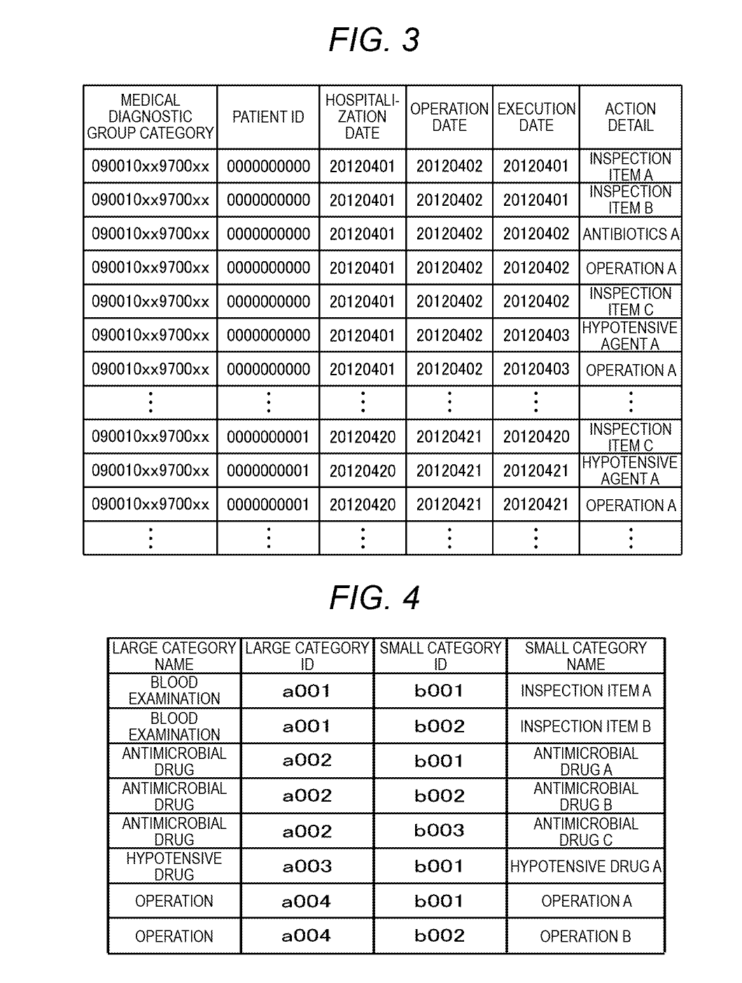

The medical care history information acquisition unit 201 acquires medical care history information regarding a medical care history of a patient from a medical care history information storage unit (not illustrated). Specifically, the medical care history information storage unit, as illustrated in FIG. 3, stores information that indicate a medical care group category, a patient ID for identifying a patient, a hospitalization date, an operation date, an execution date, and an action detail (medical care action), by associating them with one another. Here, for example, the medical care group category indicates a medical diagnostic group of a target patient, and corresponds to a code representing a disease name or a medical procedure. Meantime, the medical care history information illustrated in FIG. 3 is an illustrative example, and the present embodiment is not limited thereto. Further, the medical care history information storage unit is configured by, for example, the storage unit 112.

The category information acquisition unit 202 acquires category information for acquiring a category corresponding to an action detail included in the medical care history information from a category information storage unit (not illustrated). Here, the category information storage unit corresponds to, for example, the storage unit 112.

Specifically, for example, the category information storage unit stores the category information in which a large category name, a large category ID, a small category ID, and a small category name, are associated with each other as illustrated in FIG. 4. Here, for example, the small category name corresponds to the action detail included in the medical care history information. The large category is a category indicative of a category of the action detail, and includes a plurality of small categories. Specifically, for example, each of the “inspection item A” or the “antimicrobial agent C” illustrated in FIGS. 3 and 4 corresponds to the small category, and is included in the large category, such as for example, the “blood examination” or the “antimicrobial agent”. That is, there is a relationship where the “inspection item A” or the “inspection item B” belonging to the small category is executed in the large category “blood examination”. Meantime, a case where a category is categorized into 2 stages of the large category and the small category is exemplified in FIG. 4, but the present embodiment may be categorized into other numbers of stages. Also, the category information illustrated in FIG. 4 is an illustrative example, and the present embodiment is not limited thereto.

The category conversion unit 203 converts the small category into the large category based on the category information acquired by the category information acquisition unit 202. Specifically, the category conversion unit 203 converts, for example, the action detail in a first row of FIG. 3: “inspection item A” into the “blood examination” which is a large category name according to the category information illustrated in FIG. 4.

The medical care information acquisition unit 204 acquires medical care information made by structuring the medical care history information acquired by the medical care history information acquisition unit 201. Specifically, the medical care information acquisition unit 204 acquires the medical care information in which an execution date information that indicates a relative execution date of the medical care action indicated by each small category name for each patient ID and the large category name (medical care action information) corresponding to the each small category name are associated with each other. Further, the large category name corresponding to each small category name is acquired by the category conversion unit 203. Here, the relative execution date refers to a relative execution date from a reference date which is set in advance. Specifically, for example, when an operation date is denoted by “0” as a reference day, if the relative execution date corresponds to a day before the operation date, it is denoted by “−1”, and if the relative execution date corresponds to a day after the operation date, it is denoted by “1”. Meantime, a day, such as a hospitalization date, other than the operation date may be set as a reference day.

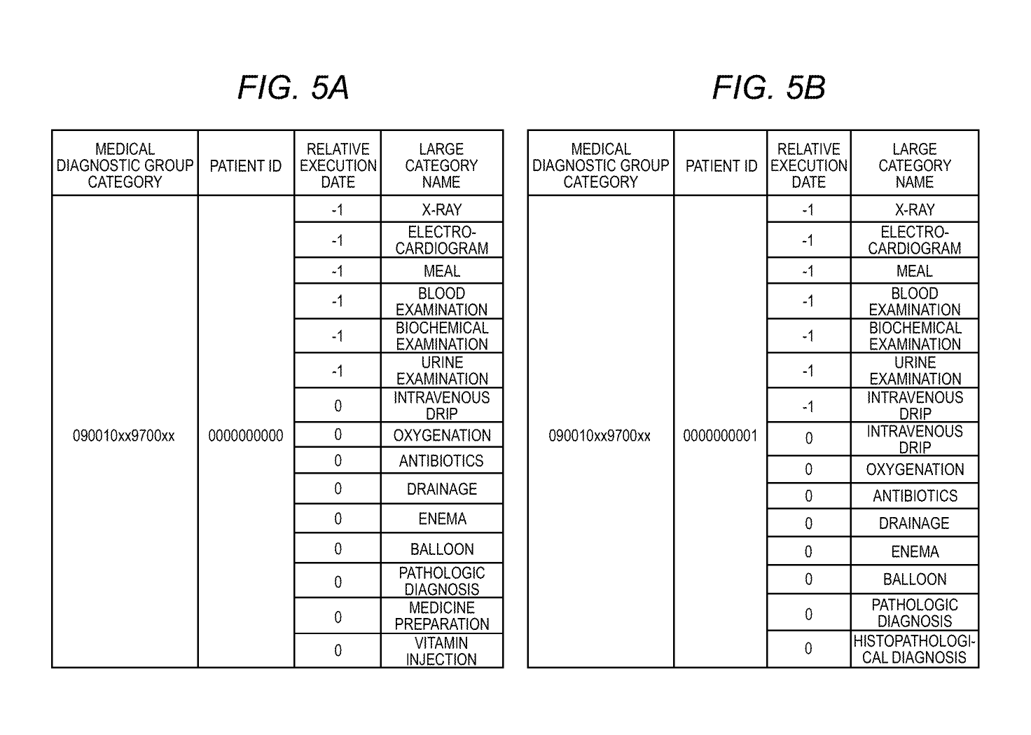

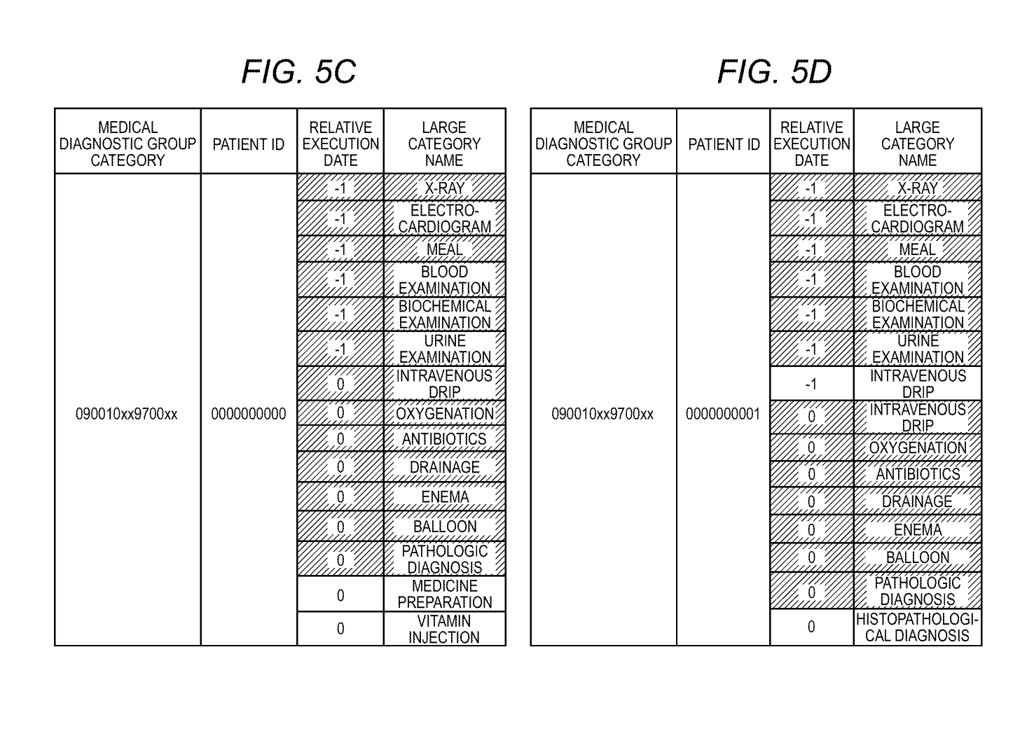

Specifically, explanation will be made with reference to FIGS. 5A and 5B. FIGS. 5A and 5B are diagrams illustrating examples of the medical care information acquired by the medical care information acquisition unit 204. As illustrated in FIGS. 5A and 5B, in the medical care information, the relative execution date (execution date information) is associated with the large category name for each patient ID. Further, in the medical care information, the medical care group category information may be associated with the patient ID, as illustrated in FIGS. 5A and 5B. Meantime, in FIGS. 5A and 5B, since different medical care information for different patient are indicated, the patient IDs are different from each other, but the medical diagnostic group category are the same with each other. That is, the medical care information constituted with the same disease name or medical procedure and the different patients are indicated in FIGS. 5A and 5B.

The pattern information acquisition unit 205 acquires the pattern information (for example, a combination of the relative execution date and the large category name) common to the medical care information for each patient acquired by the medical care information acquisition unit 204. Specifically, for example, in a case illustrated in FIGS. 5A and 5B, the pattern information acquisition unit 205 acquires a combination (denoted by hatching in FIGS. 5C and 5D) of the relative execution date and the large category commonly included in FIGS. 5A and 5B.

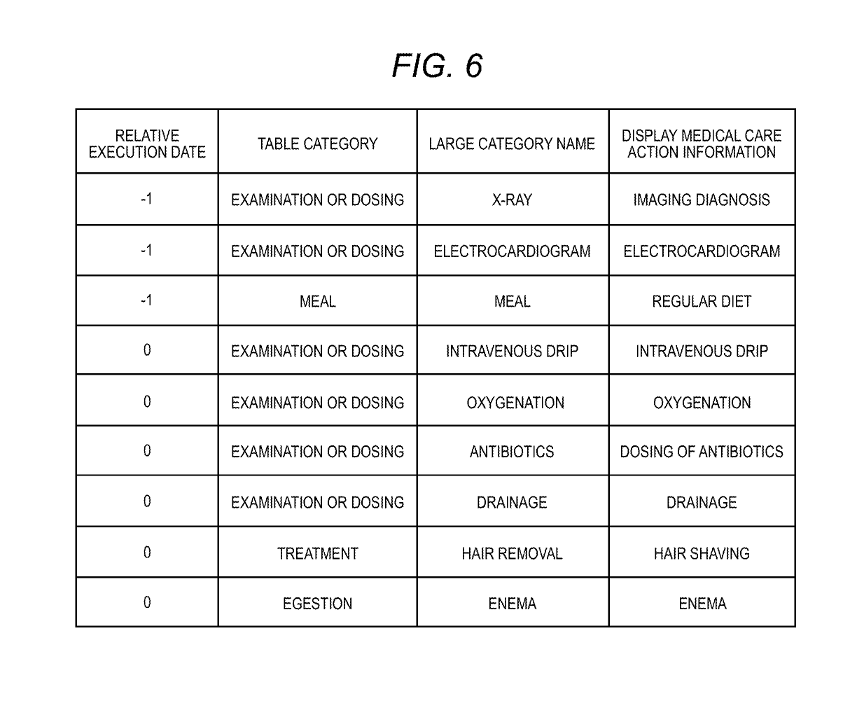

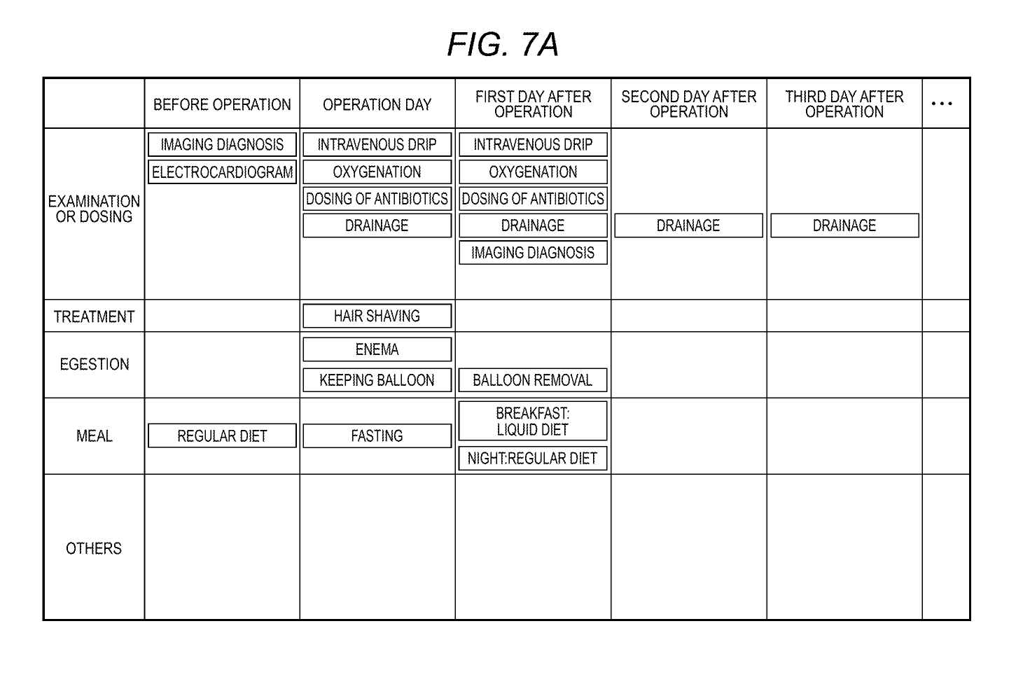

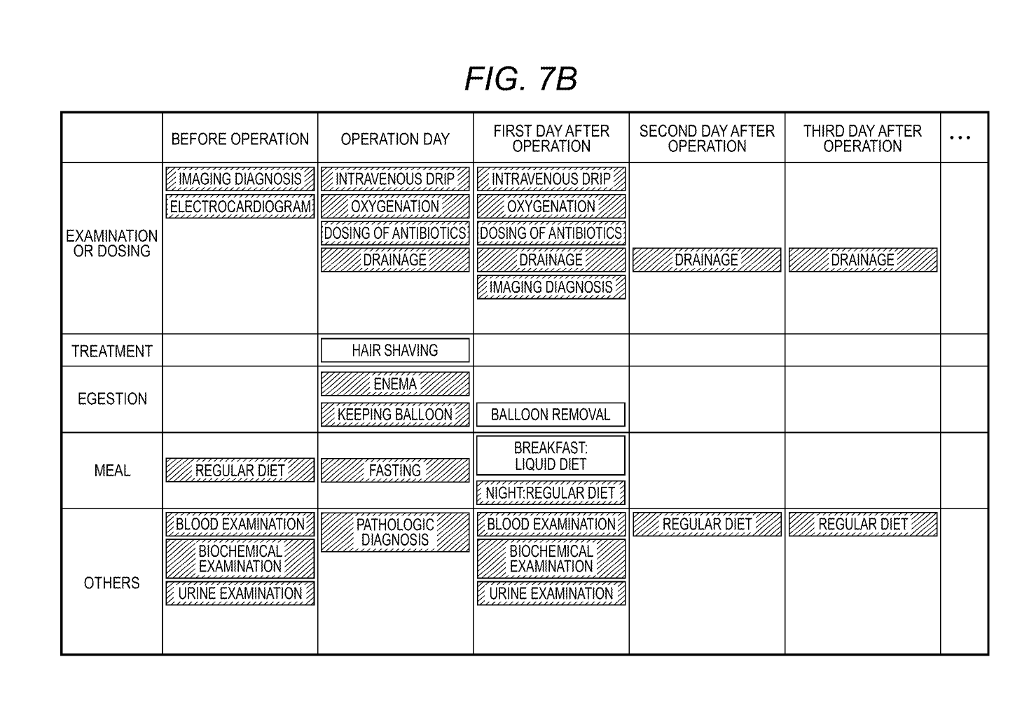

The medical care plan information acquisition unit 206 acquires the medical care plan information in which the large category name and the execution date information which are set in advance are associated with each other, from a medical care plan information storage unit (not illustrated). The medical care plan information storage unit corresponds to, for example, the storage unit 112 illustrated in FIG. 1. Meantime, the medical care plan information, as illustrated in FIG. 6, may be made in such a manner that a table category information indicative of a table category of the respective medical care action information or a display medical care action information according to the medical care action information and the medical diagnostic group category information are associated with each other when displaying in a format of a medical care plan table. Further, FIG. 7A illustrates an example of a medical care plan table generated according to the medical care plan information illustrated in FIG. 6. As illustrated in FIG. 7A, a row direction corresponds to a day from the operation date, and a column direction corresponds to the table category in the medical care plan table. Specifically, for example, in the medical care plan information of a first row of FIG. 6, the relative execution date is “−1”, the table category is “examination or dosing”, and the display medical care action information is “imaging diagnosis”, and thus the “imaging diagnosis” is displayed on a cell corresponding to the “before operation” and the “examination or dosing”.

The medical care plan display information generation unit 207 generates the medical care plan display information based on the pattern information and the medical care plan information. Specifically, for example, in a case where a combination of the medical care action information (large category name) and the execution date information which are included in the pattern information is included in the medical care plan information, the medical care plan display information generation unit 207 generates the medical care plan display information that identifies and displays the display medical care action information according to the medical care action information (large category name).

More specifically, the pattern information acquired by the pattern information acquisition unit 205 corresponds to information indicated in a hatched area of FIGS. 5C and 5D, and a case where the medical care plan information acquired by the medical care plan information acquisition unit 206 is indicated in FIG. 6 will be described as an example.

In this case, the execution date information “−1” and the large category name “X-ray” have been acquired as the pattern information, as illustrated in FIGS. 5C and 5D. Also, the combination of the “−1” and the “X-ray” has been included in FIG. 6. Thus, for example, as illustrated in FIG. 7B, the medical care plan display information generation unit 207 generates the medical care plan display information that highlights (for example, displays by coloring, hatching) the display medical care action information associated with the “−1” and the “X-ray” on items (cells) according to the table category and the date information according to the execution date information. As such, the process described above is performed on the respective combinations of the large category name and the execution date information included in the pattern information.

FIG. 7B illustrates the medical care plan display information in a case where the medical care plan display information generated as described above is displayed on, for example, the display unit 124. Meantime, in the medical care plan display information, the date information is indicated by, such as “operation date ” or “first day after operation”, but other indication may be allowed as long as it is date information of contents according to the execution date information. Further, in the above description, the display medical care action information is represented by the content different from that of the large category, but the content of the large category name may be displayed as it is in the cell of the display medical care action information.

Further, the medical care plan display information generation unit 207 generates, for example, medical care plan display information that is displayed without being highlighted by, such as coloring or hatching with respect to a medical care action, such as the “hair shaving” of FIG. 7B, which is included in the medical care plan information but not included in the pattern information.

Further, the medical care plan display information generation unit 207 generates, medical care plan display information that is highlighted on an item (cell) which is according to the execution date information and which is set in advance, corresponds to “others” of the table category of the medical care plan display information, with respect to the combination, such as a “blood examination” of FIG. 7B, of a large category name and an execution date, which are included in the pattern information but not included in the medical care plan information. Meantime, although the above description is made respect to a configuration in which the display medical care action information is arranged on a position mainly according to the table category, other configuration, such as a case where the respective display medical care action information may be arranged only, such as for example, according to an execution date information without using the table category may be adopted.

The transmission unit 208 transmits the medical care plan display information generated by the medical care plan display information generation unit 207 to the terminal 120. Also, the editing instruction information acquisition unit 209 acquires the editing instruction information that instructs to edit the medical care plan display information from the terminal 120.

Specifically, for example, the medical care plan display information is displayed on the display unit 124 of the terminal 120 based on the medical care plan display information, a user (for example, a medical doctor) inputs the editing instruction information for editing the medical care plan display information to the manipulation unit 125 of the terminal 120 while referencing the medical care plan display information, and the editing instruction information acquisition unit 209 acquires the editing instruction information. The editing unit 210 edits the medical care plan display information based on the editing instruction information.

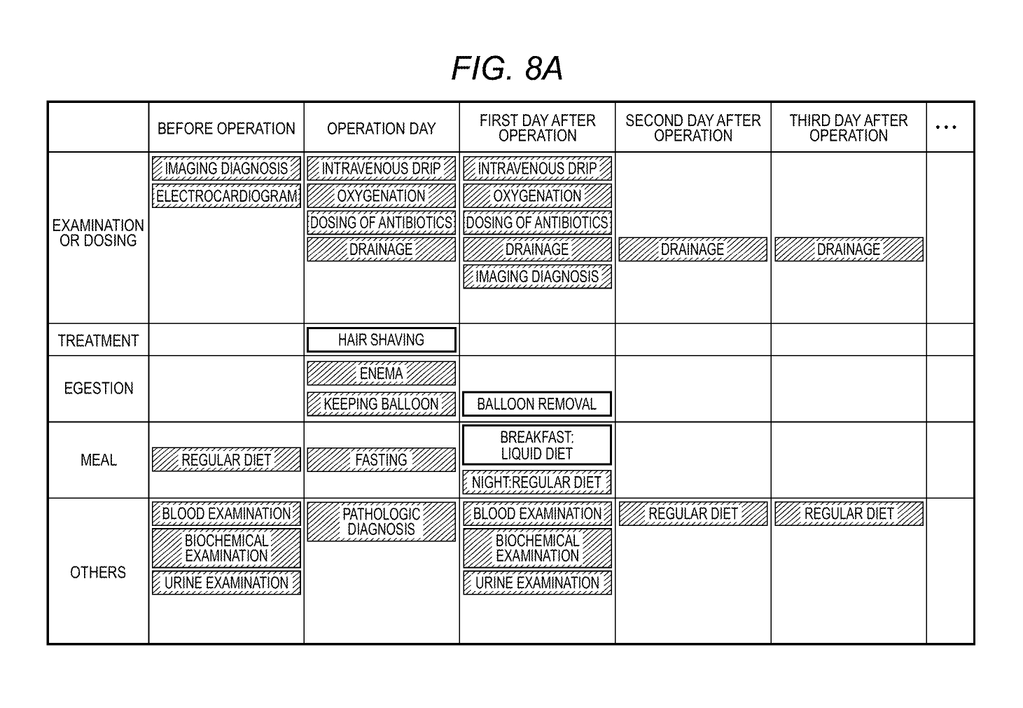

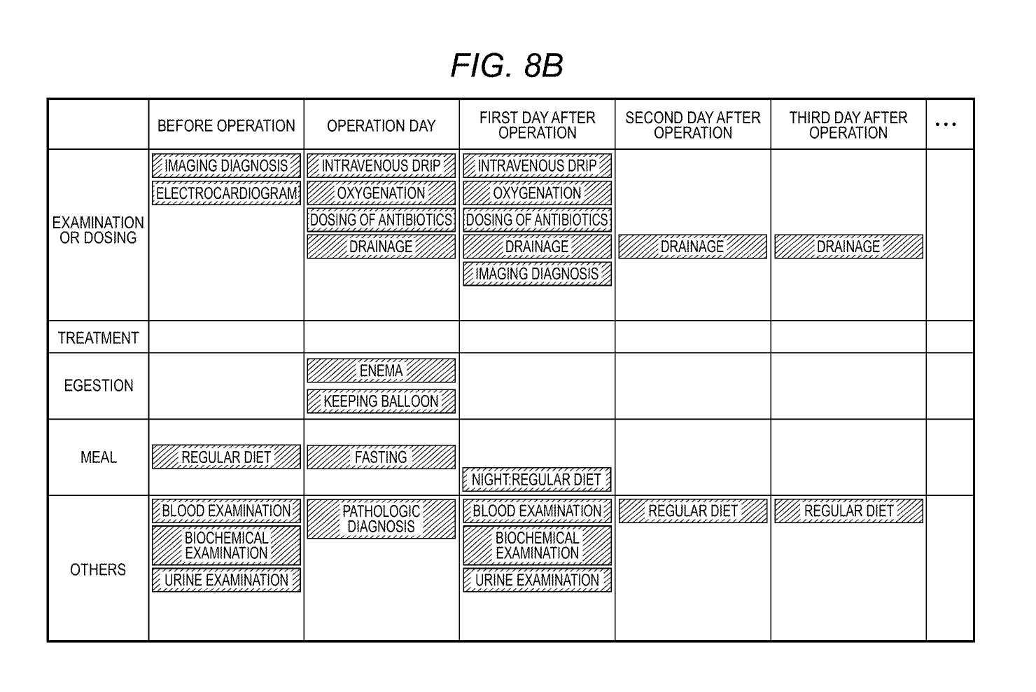

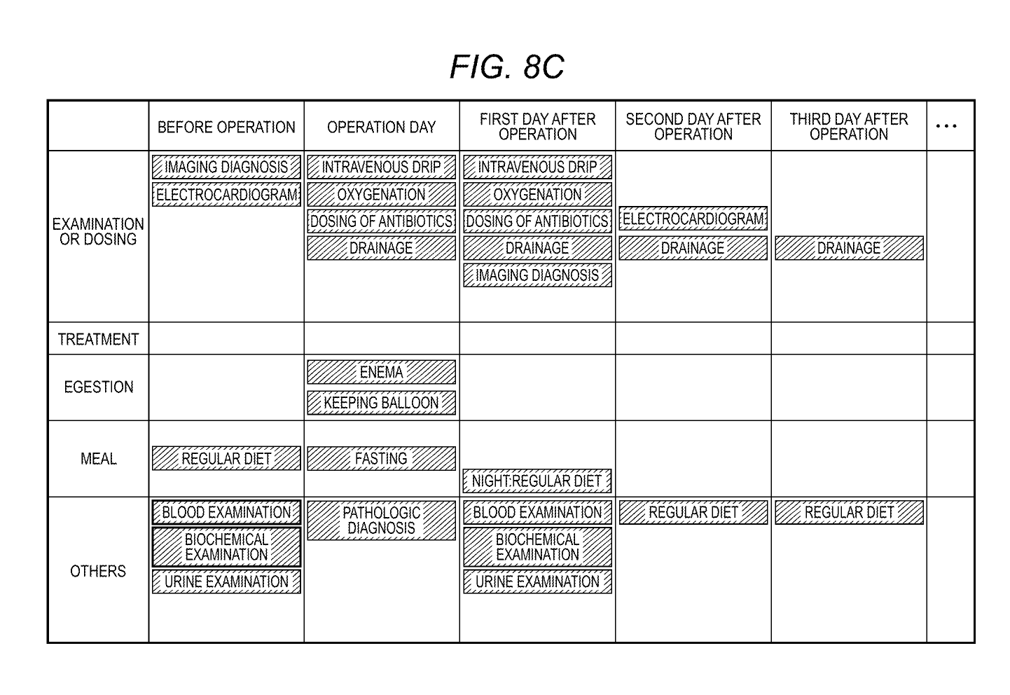

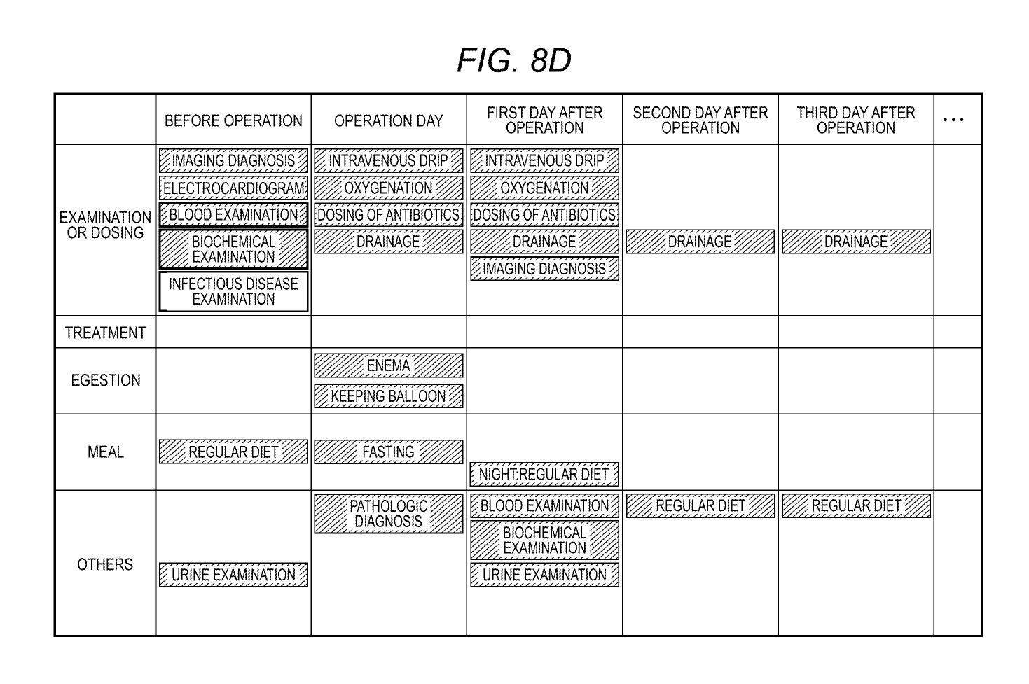

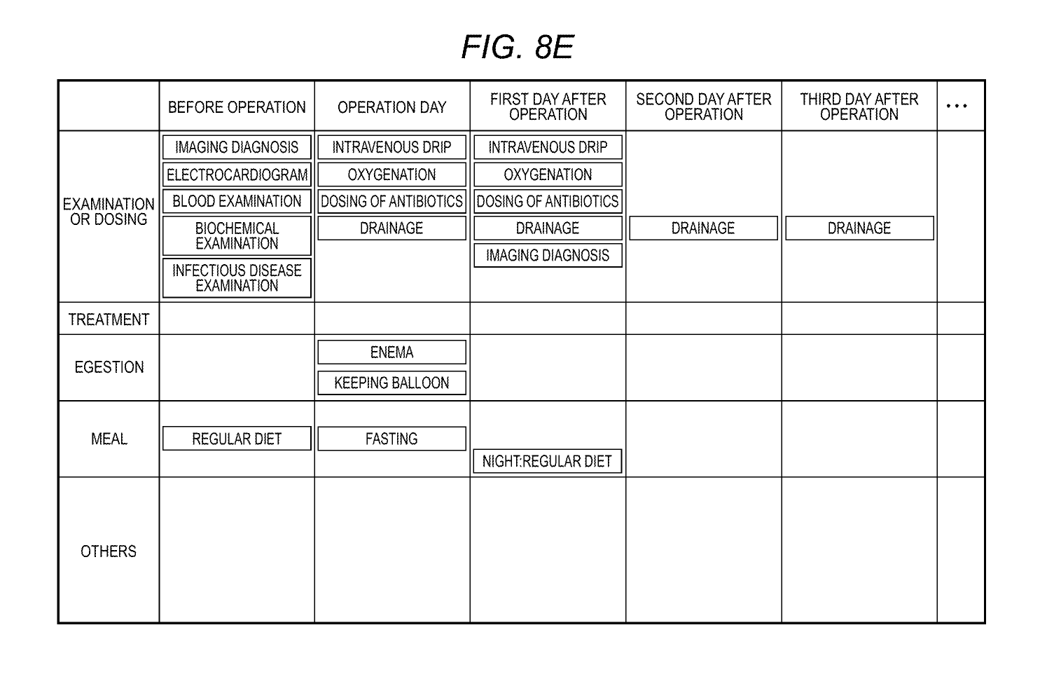

Specifically, as illustrated in FIG. 8A, when deleting the “hair shaving”, “balloon removal” and “breakfast: liquid diet” that are included in the medical care plan display information but not included in the pattern information, if a medical doctor selects these item and issues an editing instruction to delete the items through the terminal 120, the editing unit 210 deletes the items as illustrated in FIG. 8B.

Further, as illustrated in FIGS. 8C and 8D, the editing unit 210 may add an item (“blood examination” or “biochemical examination” in the “others”) included in the pattern information but not included in the medical care plan display information in the category of “examination or dosing” according to the editing instruction. Alternatively, the editing unit 210 may add a new medical care action (“infectious disease examination”) irrelevant to the pattern information according to the editing instruction.

FIG. 8E is a diagram showing a confirmed medical care plan display information in a state after which the medical doctor selects all of the items in the “others” of the pattern information and issues the editing instruction to delete these items from the medical care plan display information of FIG. 8D

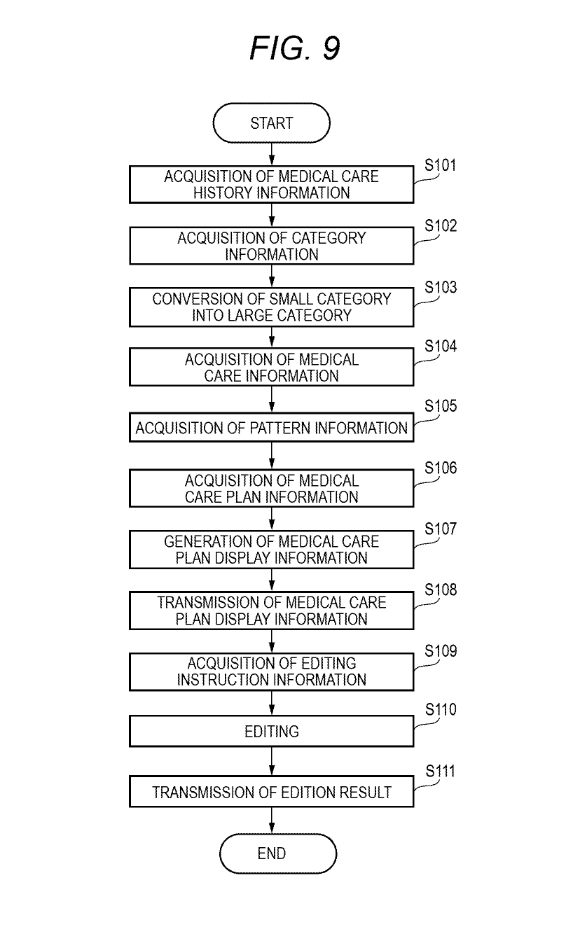

Next, a process flow of the server 110 in the present embodiment is described with reference to FIG. 9. Meantime, the process flow illustrated in FIG. 9 is an illustrative example, and the present embodiment is not limited thereto.

The medical care history information acquisition unit 201 acquires the medical care history information with respect to a medical care history of a patient from the medical care history information storage unit (S101). The category information acquisition unit 202 acquires the category information for acquiring a category corresponding to an action specification included in the medical care history information from the category information storage unit (S102). The category conversion unit 203 converts a small category into a large category based on the category information acquired by the category information acquisition unit 202 (S103).

The medical care information acquisition unit 204 acquires the medical care information in which the medical care history information acquired by the medical care history information acquisition unit 201 has been structured (S104). The pattern information acquisition unit 205 acquires the pattern information (for example, the combination of the relative execution date and the large category name) common to the medical care information for each patient acquired by the medical care information acquisition unit 204 (S105). The medical care plan information acquisition unit 206 acquires the medical care plan information in which the large category name is associated with the execution date information (S106).

The medical care plan display information generation unit 207 generates the medical care plan display information based on the pattern information and the medical care plan information (S107). The transmission unit 208 transmits the medical care plan display information generated by the medical care plan display information generation unit 207 to the terminal 120 (S108). The medical care plan display information is displayed on, for example, the display unit 124 of the terminal 120. The editing instruction information acquisition unit 209 acquires the editing instruction information that instructs to edit the medical care plan display information from the terminal 120 (S109).

The editing unit 210 edits the medical care plan display information based on the editing instruction information (S110). The edition result is transmitted to the terminal 120 by, for example, the transmission unit 208 (S111), and displayed on, for example, the display unit 124 of the terminal 120.

The present invention is not limited the above-described embodiment, but can be modified in various ways. For example, the present invention can be substituted with a configuration that is substantially the same as that disclosed in the above-described embodiment, a configuration which has the same effect as that disclosed in the embodiment, or a configuration with which the same object as that disclosed in the above-described embodiment can be achieved. For example, in the above description, a configuration in which the category information is acquired (S102), and the small category name included in the medical care history information is converted to the large category name according to the acquired category information (S103) is described. However, for example, in a case where the medical care history information is maintained under the large category name, a configuration or a process flow for the category information acquisition or conversion as described above is not necessary. Further, it may be configured such that the terminal 120 has some of the functions of the server 110. Meantime, “medical care plan preparation support apparatus” corresponds to, for example, the server 110.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A medical care plan preparation support apparatus, comprising:
a medical care information acquisition unit that acquires medical care information for each patient, in which medical care action information according to each medical care action and execution date information acquired from an execution date of each medical care action and a reference date set in advance, are associated with each other;
a pattern information acquisition unit that acquires pattern information in which the medical care action information and the execution date information which are common to at least some of a plurality of patients are associated with each other, based on the medical care information;
a medical care plan information acquisition unit that acquires medical care plan information in which the medical care action information and the execution date information which are set in advance are associated with each other; and
a medical care plan display information generation unit that generates medical care plan display information indicating the medical care plan information, which (i) highlights the medical care action information according to the pattern information, which is included in both of the medical care plan information and the pattern information and (ii) defer highlighting the medical care action information which is included in the medical care plan information and not included in the pattern information.

2. The medical care plan preparation support apparatus according to claim 1, wherein
the medical care plan display information generation unit generates the medical care plan display information that highlights the medical care action information which is included in the medical care plan information and the pattern information.

3. The medical care plan preparation support apparatus according to claim 1, wherein
the medical care plan display information is displayed in a format of a table,
in the medical care plan information, table category information corresponding to items in a row direction or a column direction of the table is associated with the execution date information, and
the execution date information corresponds to the item in the column direction or the row direction of the table.

4. The medical care plan preparation support apparatus according to claim 3, wherein
the medical care plan display information generation unit generates the medical care plan display information that displays the medical care action information which is included in the pattern information and not included in the medical care plan information on an item that corresponds to the execution date information associated with said medical care action information and corresponds to the table category information set in advance.

5. The medical care plan preparation support apparatus according to claim 1, wherein
the medical care information acquisition unit includes a medical care history information acquisition unit that acquires medical care history information in which name information indicative of a name of each medical care action, execution date information indicative of an execution date of each medical care action, and patient identification information identifying the patient are associated with each other, and
the medical care information acquisition unit acquires the medical care information by structuring the medical care history information.

6. The medical care plan preparation support apparatus according to claim 1, further comprising:
a transmission unit that transmits the medical care plan display information;
an edition information acquisition unit that acquires edition information with respect to editing of the medical care plan display information; and
an editing unit that edits the medical care plan display information based on the acquired edition information.

7. A medical care plan preparation support method executed by a processor, comprising:
acquiring medical care information for each patient, in which medical care action information according to each medical care action and execution date information acquired from an execution date of each medical care action and a reference date set in advance, are associated with each other;
acquiring pattern information in which the medical care action information and the execution date information which are common to at least some of a plurality of patients are associated with each other, based on the medical care information;
acquiring medical care plan information in which the medical care action information and the execution date information which are set in advance are associated with each other; and
generating medical care plan display information indicating the medical care plan information, which (i) highlights the medical care action information according to the pattern information, which is included in both of the medical care plan information and the pattern information and (ii) defer highlighting the medical care action information which is included in the medical care plan information and not included in the pattern information.

8. A non-transitory computer readable medium storing a program causing a computer to execute a process for a medical care plan preparation support, the process comprising:
acquiring medical care information for each patient, in which medical care action information according to each medical care action and execution date information acquired from an execution date of each medical care action and a reference date set in advance, are associated with each other;
acquiring pattern information in which the medical care action information and the execution date information which are common to at least some of a plurality of patients are associated with each other, based on the medical care information;
acquiring medical care plan information in which the medical care action information and the execution date information which are set in advance are associated with each other; and
generating medical care plan display information indicating the medical care plan information, which (i) highlights the medical care action information according to the pattern information, which is included in both of the medical care plan information and the pattern information and (ii) defer highlighting the medical care action information which is included in the medical care plan information and not included in the pattern information.
